(19) United States
(12) Patent Application Publication
(10) Pub. No.: US 2011/0084552 A1
(43) Pub. Date: Apr. 14, 2011

(54) Power Management Methodology

(75) Inventor: Erik Fossum Færevaag, Bergen (NO)

(73) Assignee: Energy Micro AS, Oslo (NO)

(21) Appl. No.: 12/904,704

(22) Filed: Oct. 14, 2010

Related U.S. Application Data
(60) Provisional application No. 61/251,604, filed on Oct. 14, 2009.

(51) Int. Cl. H02J 4/00

(52) U.S. Cl. 307/31

(57) ABSTRACT

A power management system for regulating supply voltage in at least two selectable power modes with low power, minimal leakage current and quicker startup times is disclosed. The power management system includes at least two regulators having regulator inputs and regulator outputs. The regulator inputs are respectively coupled to at least two voltage domains, wherein the voltage domains have different load traits and/or requirements. The power management system also includes at least one switch disposed between the regulator outputs so as to selectively interconnect the regulator outputs based on the selected power mode.

### CROSS-REFERENCE TO RELATED APPLICATION

This application claims priority to U.S. Provisional Application Ser. No. 61/251,604, filed on Oct. 14, 2009.

### BACKGROUND

1. Technical Field

The present disclosure relates to power management schemes and topologies for integrated circuits, and more particularly, to an improved regulator system and method for regulating supply voltages with minimal power consumption, quicker startup times and reduced leakage.

2. Description of the Related Art

Voltage regulators are commonly used in the electrical arts for supplying a stable supply voltage to a particular load or voltage domain. Such regulators typically employ a single regulator which continuously draws current at a constant rate that is independent of the load connected at the output of the regulator. The overall current that is drawn by such regulators is generally in excess of what is actually required by any particular load. Moreover, the current drawn by a regulator may be supplied to the entire digital domain of a particular load, even when it is only a small part of the load that actually requires current while operating in a low power state or mode. This results in a substantial amount of leakage current, or current which flows through the logic that is connected to the power supply while powered off. Such leakage current, for a system which spends most of its time in a powered off or sleep mode, may translate into a substantial waste of energy and resources. Accordingly, efforts have been made in the electrical arts to improve upon such single-regulator schemes, and to reduce the overall power consumed by regulators without negatively effecting performance. While currently existing regulators and related schemes may aid in conserving energy to some limited degree, there are still significant drawbacks.

In order to save power, single-regulator schemes may power off regulators during times when they are not needed. However, regulators typically require substantially large internal or external decoupling storage devices, such as capacitors, in order to supply instantaneous energy. Powering off such regulators also discharges substantially large amounts of charge stored in the associated decoupling capacitors. Accordingly, these decoupling capacitors must be recharged each and every time the digital domain of any particular load is powered on. This consumes a considerable amount of energy and time. Moreover, any single-regulator system and scheme that is designed to operate and drive substantially broad load ranges will unnecessarily waste considerable amounts of energy when operating only low loads, or the low power domains of a load.

Therefore, there is a need for an improved power management system or regulator scheme that can significantly reduce power consumption without negatively affecting performance in both high and low power load domains. Moreover, there is a need for an alternative to the single-regulator system that is capable of operating different domains of a load while minimizing leakage current. Accordingly, there is also a need for retaining the charge stored in a decoupling capacitor and minimizing startup times.

### SUMMARY OF THE DISCLOSURE

In satisfaction of the aforenoted needs, a power management methodology for providing a series of regulators directed to different power domains of a load so as to reduce current draw, and retain decoupling capacitance charge for faster startup times and minimized current leakage is disclosed.

A power management system for regulating supply signals to at least first and second domains of load, wherein each domain is distinguishable by distinct load traits or characteristics, wherein the characteristics may pertain to, for example, random access memory (RAM) retention, startup-times, or the like, is disclosed. The power management system includes a first regulator having a first input and a first output, and a second regulator having a second input and a second output. The first output is configured to supply a first regulated signal to the first domain while the second output is configured to supply a second regulated signal to the second domain. The power management system also includes a switch that is disposed between the first and second outputs. The switch is configured to selectively interconnect the first and second outputs.

In a refinement, the power management system further includes a decoupler that is coupled to the second output.

In another refinement, the first regulator is configured to regulate relatively high drive current.

In another refinement, the first regulator includes an adaptively biased regulator.

In another refinement, the second regulator is configured to regulate relatively low drive voltage.

In another refinement, the second regulator includes a low power biased regulator.

In another refinement, the switch is an ultra low resistance switch.

In another refinement, the switch is a low resistance complementary metal-oxide semiconductor (CMOS) switch.

In another refinement, the decoupler couples at least the second output of the second regulator to at least one storage device.

A method for regulating a voltage in low and high power modes to minimize current consumption and having minimal leakage current and quicker switching times between the low and high power modes is also disclosed. Specifically, the method includes the steps of enabling a high drive regulator during a first startup and charge period of the high power mode, enabling the high drive regulator during the high power mode, enabling a low drive regulator during the low power mode, retaining the charge at a storage device for a duration of the low power mode, and re-enabling the high drive regulator for subsequent high power modes, each subsequent high power mode having subsequent startup periods.

In a refinement, each subsequent startup period is substantially shorter in duration than the first startup period.

In another refinement, the external storage device includes at least one substantially large capacitor.

In another refinement, the step of enabling the high drive regulator occurs after a validation signal indicates that an output of the high drive regulator has settled and reached a nominal operating voltage.

In another refinement, the external storage device is selectively coupled to an output of the high drive regulator using a low resistance switch.

In yet another refinement, the low resistance switch is a CMOS switch.

Furthermore, a power management system for regulating supply voltage in at least two selectable power modes with minimal current consumption, minimal leakage current and quicker startup times is disclosed. The power management system includes at least two regulators having regulator outputs. The regulator outputs are respectively coupled to at least two voltage domains, wherein the voltage domains typically have different load characteristics. The power management system also includes at least one switch disposed between the regulator outputs so as to selectively interconnect the regulator outputs based on the selected power mode.

In a refinement, the power management system further includes at least one decoupler in connection with the at least one switch so as to couple one or more outputs of the regulators to an external storage device.

In another refinement, at least one of the regulators is configured to regulate relatively high drive current.

In another refinement, at least one of the regulators is configured to regulate relatively low drive current.

In another refinement, the switch is an ultra low resistance switch.

In yet another refinement, the external storage device includes at least one substantially large external capacitor.

Other advantages and features will be apparent from the following detailed description when read in conjunction with the attached drawings.

### BRIEF DESCRIPTION OF THE DRAWINGS

The disclosed power management systems and methodology are described more or less diagrammatically in the accompanying drawings wherein:

FIG. 1 is a schematic of an exemplary power management system constructed in accordance with this disclosure, as applied to a load having one or more power domains;

FIG. 2 is a schematic of another exemplary power management system;

FIG. 3A is a state diagram of exemplary operations of the power management system of FIG. 2; and

FIG. 3B is a timing diagram of exemplary operations of the power management system of FIG. 2.

It should be understood that the drawings are not necessarily to scale and that the embodiments are sometimes illustrated by graphic symbols, phantom lines, diagrammatic representations and fragmentary views. In certain instances, details which are not necessary for an understanding of this disclosure or which render other details difficult to perceive may have been omitted. It should be understood, of course, that this disclosure is not limited to the particular embodiments and methods illustrated herein.

### DETAILED DESCRIPTION OF THE DISCLOSURE

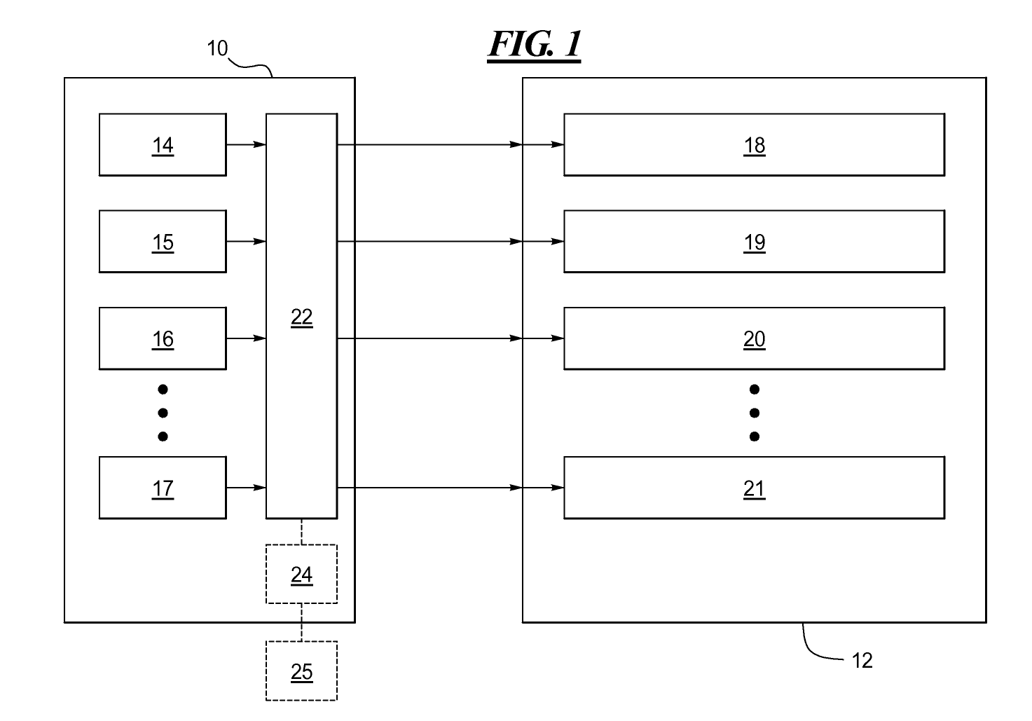

FIG. 1 illustrates an exemplary power management or regulator system 10 for supplying regulated voltage and/or current to a load 12. The regulator system 10 may essentially include one or more regulators 14-17 which respectively correspond to one or more domains 18-21 of the load 12, wherein each domain 18-21 may be distinguishable by its respective load, voltage or current requirements, traits and/or usage. Furthermore, each domain 18-21 may be distinguishable by distinct load characteristics, wherein the characteristics pertain to, for example, random access memory (RAM) retention, startup-times, or the like. The output of each regulator 14-17 may be coupled directly to the input of its respective domain 18-21. The regulator system 10 may further include one or more switches 22 disposed between two or more regulator 14-17 outputs. Moreover, the one or more switches 22 may be configured so as to allow any two or more regulator 14-17 outputs to be interconnected. Optionally, the regulator system 10 may include at least one decoupler 24 coupled to the one or more switches 22 and at least one of the regulators 14-17. In particular, the decoupler 24 may be configured to couple any one or more of the regulator 14-17 outputs to a storage device 25. The decoupler 24 may employ storage devices, such as an external capacitor, an internal capacitor, more than one capacitor, or the like.

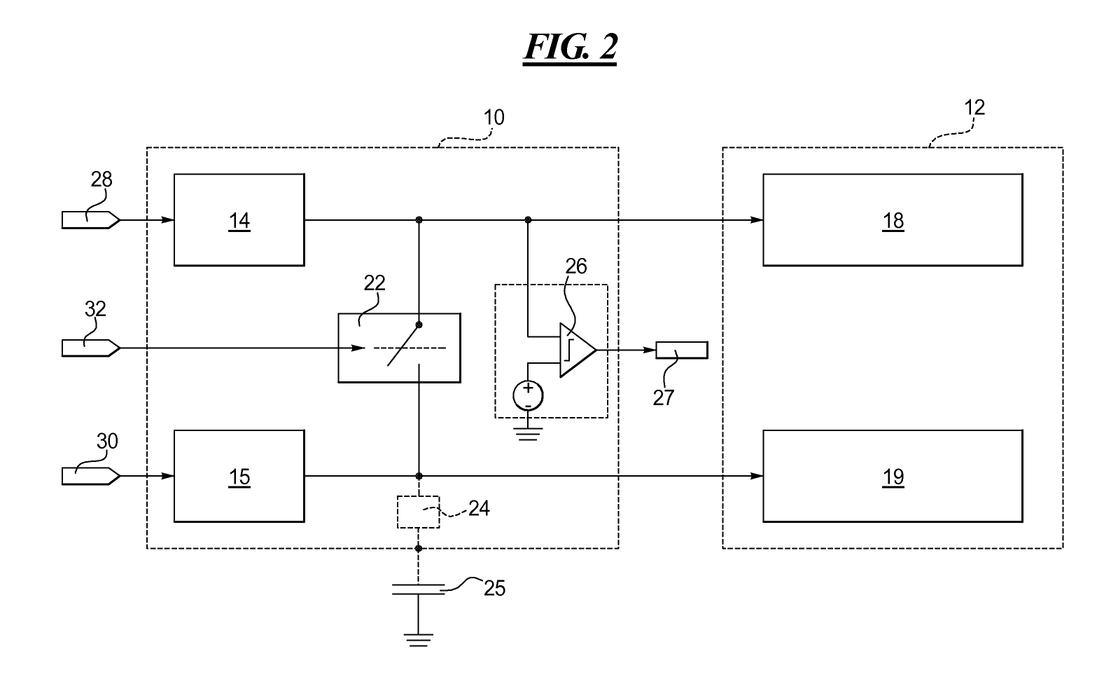

Referring to FIG. 2, another exemplary power management or regulator system 10 for supplying regulated voltage and/or current to a load 12 is provided. As in the previous embodiment, the regulator system 10 may include one or more regulators 14, 15 which respectively correspond to one or more domains 18, 19 of the load 12. In particular, the regulator system 10 may include a first regulator 14 which corresponds to a first domain 18 of the load 12, and a second regulator 15 which corresponds to a second domain 19 of the load 12, wherein each domain 18, 19 is distinguished by load, voltage or current traits or characteristics. The output of each regulator 14, 15 may be coupled to the input of its respective domain 18, 19. The regulator system 10 may further include at least one switch 22 disposed between the regulator 14, 15 outputs so as to allow the output of the first regulator 14 to connect to the output of the second regulator 15. The switch 22 may include, for example, an ultra low resistance complementary metal-oxide semiconductor (CMOS) switch, or any other suitable switch used in the art. Furthermore, the regulator system 10 may include at least one decoupler 24 coupled to the switch 22 and the output of the second regulator 15. As in the particular embodiment of FIG. 2, the decoupler 24 may be configured to couple the regulator 14, 15 outputs to a storage device 25, such as an external capacitor, or the like. The regulator system 10 of FIG. 2 may optionally provide a comparator 26, or the like, configured to output a validation signal 27 indicative of a status of the signal output by the first regulator 14.

As previously disclosed with reference to FIG. 1, each of the domains 18-21 of the load 12 of FIG. 2 may correspond to distinct sectors of the load 12 that are distinguishable by their load, voltage or current needs and characteristics. For example, the first domain 18 may be characterized as a high power domain which consumes relatively high power and exhibits normal leakage current. Such high power domains may be representative of, for instance, a controller, microcontroller, processor, microprocessor, a central processing unit (CPU), or the like, capable of operating at significantly high clock frequencies. Accordingly, the first regulator 14 may be configured to include a high drive regulator, for example, an adaptively biased regulator, suitable for driving the first domain 18, the second domain 19, or combinations thereof. When employing an adaptively biased regulator, the bias current of the first regulator 14 may further be configured to as a predetermined percentage of the output current thereof. Similarly, the second domain 19 may be characterized as a low power or always-on domain which consumes relatively low power and exhibits low leakage current. Operations pertaining to the low power domains may include, for instance, the retention of random access memory, or any other low power and/or always-on operation. Accordingly, the second regulator 15 may be configured to include a low power biased regulator, or the like, suitable for driving and maintaining low power operations within the second, or always-on, domain 19. Each of the first regulator 14, second regulator 15 and switch 22 of FIG. 2 may be controlled according to a predetermined scheme of operation from a control source external to the regulator system 10. Moreover, the regulator system 10 may be provided with a first input 28, a second input 30 and a switch input 32 through which enabling or disabling signals may be supplied to the first regulator 14, second regulator 15 and switch 22 of FIG. 2, respectively.

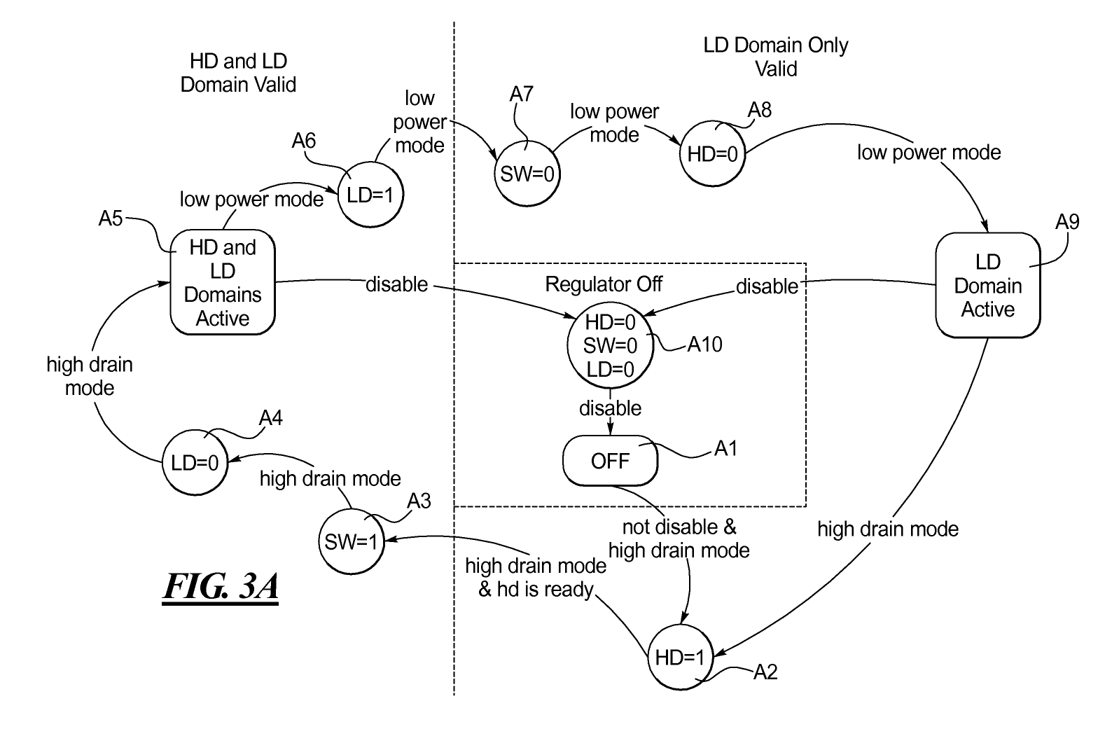

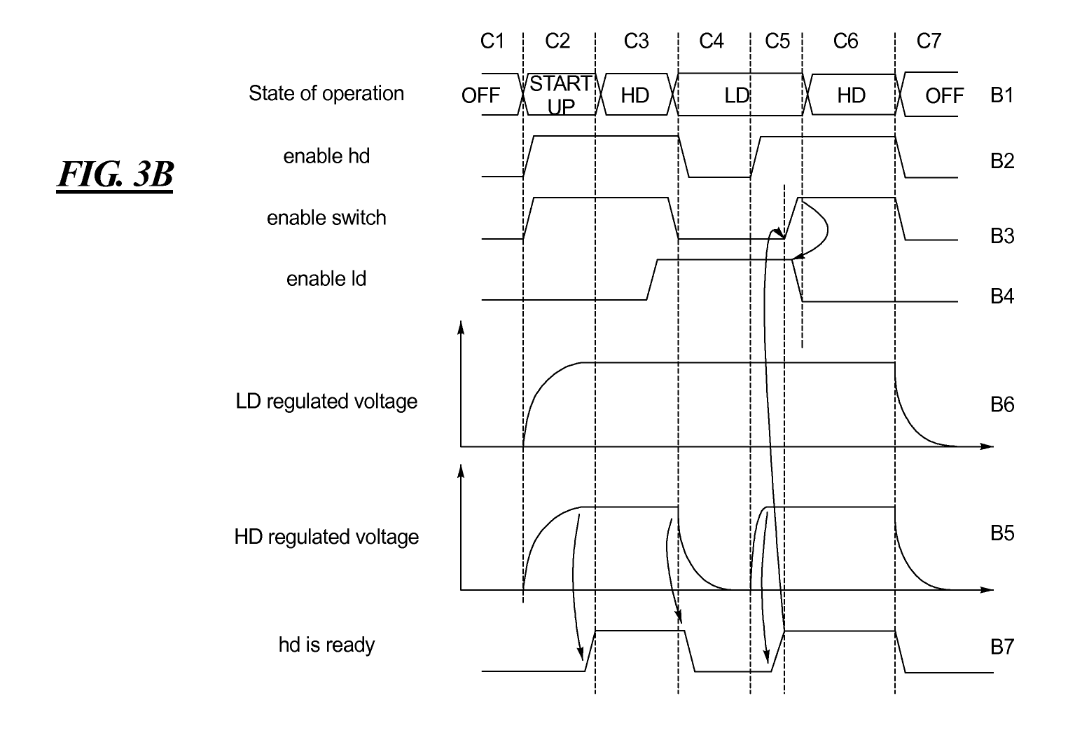

Turning now to FIGS. 3A and 3B, exemplary operations of the regulator system 10 of FIG. 2 are provided in the form of a state diagram and a corresponding timing diagram. As shown, the regulator system 10 may initially be in an off state A1 where both of the first, or high drive, regulator 14 and the second, or low drive, regulator 15 are disabled. The switch 22 may also be disabled during state A1 such that the high drive regulator 14 is not coupled to the decoupler 24 or the decoupling external capacitor 25. This may be demonstrated, for example, during a period C1 in the corresponding signals B1-B7 of FIG. 3B. The high drive regulator 14 may be enabled in a state A2 while the switch 22 may be closed in a state A3. As it is not yet needed, the low drive regulator 15 may be left as disabled in a state A5. The corresponding changes may be illustrated by the signals B1-B7 of during a period C2, as indicated in FIG. 3B. The closed switch 22 may form a connection between the output of the high drive regulator 14 and the decoupler 24, and thus, the decoupling capacitor 25. Accordingly, while the output of the high drive regulator 14 settles to a nominal operating voltage and/or current level during period C2, the high drive regulator may also serve to charge the external capacitor 25.

Once the high drive regulator 14 has settled as shown by signal B5 of FIG. 3B during a period C3, the regulator system 10 may provide a validation signal 27, B7, indicating that the regulator system 10 is ready for high load operations, for instance, a processor operating at high clock frequencies. Once such a validation signal 27, B7 has been generated, the switch 22 may be closed and the regulator system 10 may continue operating in a high power mode and use the high drive regulator 14 to supply voltage and/or current to both high and low power domains 18, 19, as in a state A5. Alternatively, the regulator system 10 may be operated in a low power mode wherein the high power domain 18 is unloaded. For instance, in a state A6 of FIG. 3A corresponding to period C3 of FIG. 3B, the low drive regulator 15 may be enabled to begin operations in the low power mode. In a state A7 or period C4, the switch 22 may be opened such that the charge stored in the external capacitor 25 is only accessible to the low drive regulator 15 and the low power domain 19. The high drive regulator 14 may also be disabled in a state A8 or period C4 such that the unneeded high power domain 18 is inactive.

During the low power mode, or state A9, regulated voltage and/or current supplied to the low power domain 19 may be optimally maintained while the charge stored in the external capacitor 25 is retained. Furthermore, as the switch 22 is opened and the voltage at the high power domain 18 is null, leakage current in the high power domain 18 may be substantially reduced and minimized. When the high power domain 18 must subsequently be powered on, the high drive regulator 18 may be re-enabled, as shown in state A2 of FIG. 3A, or during a period C5 as demonstrated in FIG. 3B. Notably, the duration of period C5, or the subsequent settling time of the high drive regulator 18, is substantially shorter than the duration of period C2, or the initial settling time of the high drive regulator 14. This is because the charge at the decoupling capacitance has been retained in the external capacitor 25, and because the internal capacitance in the high power domain, 18, is significantly smaller than the initially charged capacitance of the system, 18, 19, 24 and 25. As the relatively large external capacitor 25 has been precharged and retained, the high drive regulator 14 is able to settle at a much faster rate, and further, capable of switching between low and high power modes very quickly. Additionally, as the decoupling capacitor 25 does not discharge between modes, and because the high drive regulator 14 does not need to recharge the capacitor 25 between modes, excess energy is not wasted. Once the high drive regulator 14 settles, as shown during end of period C5 of FIG. 3B, the switch 22 may be closed during the states A2 of FIG. 3A. As the high drive regulator 14 is able to power both high and low power domains 18, 19, the low power regulator 15 may be disabled in a state A4, or as represented by signal B4 during period C6 in FIG. 3B. Finally, the regulator system 10 may be turned off in a state A10, by disabling each of the high and low drive regulators 14, 15 and opening switch 22, as correspondingly shown in period C7 of FIG. 3B.

Although certain states and sequences thereof have been disclosed herein, alternative states and combinations thereof will be apparent to those skilled in the art.

### INDUSTRIAL APPLICABILITY

In satisfaction of the above-identified needs, an improved power management system and regulator scheme is disclosed that can significantly reduce power consumption without negatively effecting performance in both high and low power load domains. This is accomplished by incorporating multiple regulators that are designed to drive different power domains of a particular load, wherein each power domain has different load characteristics and/or requirements. One or more switches selectively interconnect the outputs of the regulators with an external capacitor. Each regulator and switch is individually controlled according to the power management methodology to retain the decoupling capacitance, minimize leakage current, minimize startup and switching times, and to conserve overall power consumption.

While only certain embodiments have been set forth, alternatives and modifications will be apparent from the above description to those skilled in the art. These and other alternatives are considered equivalents and within the spirit and scope of this disclosure and the appended claims.

What is claimed:

1. A power management system for regulating supply signals to at least first and second domains of load, wherein each domain is distinguishable by distinct load traits or requirements, comprising:
a first regulator having a first input and a first output, the first output being configured to supply a first regulated signal to the first domain;
a second regulator having a second input and a second output, the second output being configured to supply a second regulated signal to the second domain; and
a switch disposed between the first and second outputs and configured to selectively interconnect the first and second outputs.

2. The system of claim 1 further comprising a decoupler coupled to the second output.

3. The system of claim 1, wherein the first regulator is configured to regulate relatively high drive current.

4. The system of claim 1, wherein at least one of the first and second regulators includes an adaptively biased regulator.

5. The system of claim 4, wherein a bias current of the first regulator is configured to be a percentage of the first output current.

6. The system of claim 1, wherein the second regulator is configured to regulate one or more low power domains.

7. The system of claim 1, wherein the second regulator includes a low power biased regulator.

8. The system of claim 1, wherein the switch is an ultra low resistance switch.

9. The system of claim 1, wherein the switch is a low resistance complementary metal-oxide semiconductor (CMOS) switch.

10. The system of claim 2, wherein the decoupler couples at least the second output of the second regulator to one or more storage devices.

11. The system of claim 1, wherein the switch is configured to enable the first regulator after a validation signal indicates that the first output has settled and reached a nominal operating voltage.

12. A method for regulating a voltage in low and high power modes to minimize current consumption and having minimal leakage current and faster switching between the low and high power modes, comprising the steps of:
enabling a high drive regulator during a first startup and charge period of the high power mode;
enabling the high drive regulator during the high power mode;
enabling a low drive regulator during the low power mode;
retaining a charge at a storage device for a duration of the low power mode; and
re-enabling the high drive regulator for subsequent high power modes.

13. The method of claim 12, wherein each subsequent startup period is substantially shorter in duration than the first startup period.

14. The method of claim 12, wherein the storage device includes at least one substantially large capacitor.

15. The method of claim 12, wherein the step of enabling the high drive regulator occurs after a validation signal indicates that an output of the high drive regulator has settled and reached a nominal operating voltage.

16. The method of claim 12, wherein the storage device is selectively coupled to an output of the high drive regulator using a low resistance switch.

17. The method of claim 16, wherein the low resistance switch is a complementary metal-oxide semiconductor (CMOS) switch.

18. A power management system for regulating supply voltage in at least two selectable power modes with minimal current consumption, minimal leakage current and quicker startup times, comprising:
at least two regulators having regulator outputs, the regulator outputs being respectively coupled to at least two voltage domains, the voltage domains having different load characteristics, traits and/or requirements; and
at least one switch disposed between the regulator outputs so as to selectively interconnect the regulator outputs based on the selected power mode.

19. The system of claim 18 further comprising one or more decouplers in connection with the at least one switch so as to couple one or more outputs of the regulators to a storage device.

20. The system of claim 18, wherein at least one of the regulators is configured to regulate relatively high drive current.

21. The system of claim 18, wherein at least one of the regulators is configured to regulate relatively low drive current.

22. The system of claim 18, wherein the switch is an ultra low resistance switch.
